(19) United States
(12) Patent Application Publication
(10) Pub. No.: US 2004/0244731 A1
(43) Pub. Date: Dec. 9, 2004

(54) 4-stroke internal combustion engine with angular and alternate movements of the piston

(76) Inventor: Manuel Lobo Da Silva E. Sousa, Carnaxide (PT)

Correspondence Address: LADAS & PARRY, 26 WEST 61ST STREET, NEW YORK, NY, 10023, US

(21) Appl. No.: 10/488,429

(22) PCT Filed: Jan. 21, 2002
(86) PCT No.: PCT/PT02/00001

(30) Foreign Application Priority Data
Sep. 17, 2001 (PT) 102665-V

(51) Int. Cl. F02B 53/00

(52) U.S. Cl. 123/18 A

(57) ABSTRACT

The 4-stroke internal combustion engine with angular and alternate movement of the pistons is different in relation to the existing actually because the movement of their pistons will be neither linear alternate, like in OTTO engine, nor integrally rotative, like in the WANKEL engine. Then, the presented engine gives up the pieces, which have the purpose to change the linear and alternate movement of the pistons into rotative movement, i.e. connecting rods/cranks, like in OTTO engine, because it is possible make the transmission of the angular and alternate movement of the pistons to the motor shaft without any change of the fundamental characteristics of the piston movements. Also the piston movements of the presented engine are not integrally rotative like in WANKEL engine, but alternate, like in OTTO engine. This situation is advantageous because it is possible increase the compression rate, according the rotation level of the engine and so, increases the energetic output to the high rotation levels. On the other hand, the pistons of the presented engine have double face, receiving then, the explosion impulses, on both faces, sequentially in one and another angular movement direction. To achieve that, the cylinders must have toric format in order to allow the angular movement of the pistons and also, they must have double combustion chamber, by cylinder, in order to obtain the explosion action over the piston faces, in one and another rotation direction.

The present invention is about a four-stroke internal combustion engine with angular and alternative movement of the pistons, following the OTTO thermodynamic cycle and using combustibles that make, with air, explosive mixtures.

The actual internal combustion engines are, mainly, of two types:

The first one (OTTO engine) has rectilinear cylinders and the piston movements are to-and-fro/rectilinear. In order to obtain, on motor shaft, a continuous rotative movement, it is necessary interpose a connecting rod/rank system, between the pistons and motor shaft, to change the linear movement of the pistons in a continuous rotative movement on the motor shaft.

The second type (WANKEL engine) has one special shaped piston, which receives the mixture explosion action, on its faces and thus, it rotates within an equally special shaped cylinder, transmitting its rotating movement directly to the motor shaft.

The present invention is different because it is referring to an engine, which has neither to-and-fro/rectilinear movement of the pistons, nor continuous rotative movement of the pistons. Thus, the pistons of the presented engine have to-and-fro/angular movements and so, the cylinders must have a toric format.

Using the annexed figures to explain the composition and general operation of the invention, we have:

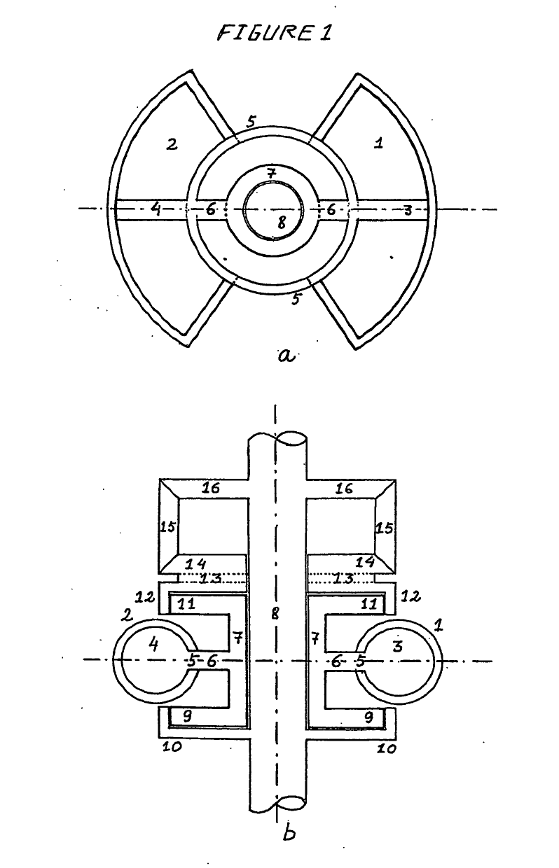

The FIG. 1a shows a transversal cut of the engine, where we can see two toric cylinders (1) and (2) having in its interior two sliding pistons (3) and (4), being one piston by cylinder. Both cylinders have two combustion chambers, being one in each extremity of each cylinder, making a total of four combustion chambers to the engine. The two pistons are diametrically opposed and they are laterally and rigidly connected to one annular slider (5). That slider is inserted in an adjusted annular aperture open on the lesser diameter surface of the toric cylinders. The other side of the annular slider is also rigidly connected at two cranks (6) and (6) which are sequential in relation to the pistons. Finally, the two cranks are rigidly fixed to one hollow axle called crank axle (7), which encircle, without touching, another axle, which is the motor shaft (8).

The FIG. 1b represents a longitudinal cut of the engine, where we can see, beyond the components already referred at FIG. 1a description, plus the following:

On each extremity of the crank axle there is one Activating System for the Engine Shaft (ASES), making a total of two ASES. Each ASES are settled by one entry element and one outlet element So, the first ASES is settled by the entry element (9) and the outlet element (10). The second ASES is settled by another entry element (11) and outlet element (12). The first ASES has its entry element rigidly fixed to one crank axle extremity and the outlet element rigidly fixed to the motor shaft. The second ASES has its entry element rigidly fixed to the other crank axle extremity and its outlet element fixed to one axle (13) who makes the liaison between the outlet element of the second ASES and one special gear system which is settled by one entry gear (14), four intermediate gears (15) and one outlet gear (16) which will be rigidly fixed to the motor shaft. So, only the outlet gears of both ASES are rigidly fixed to the motor shaft and all other components of the engine do not have any contact with the motor shaft.

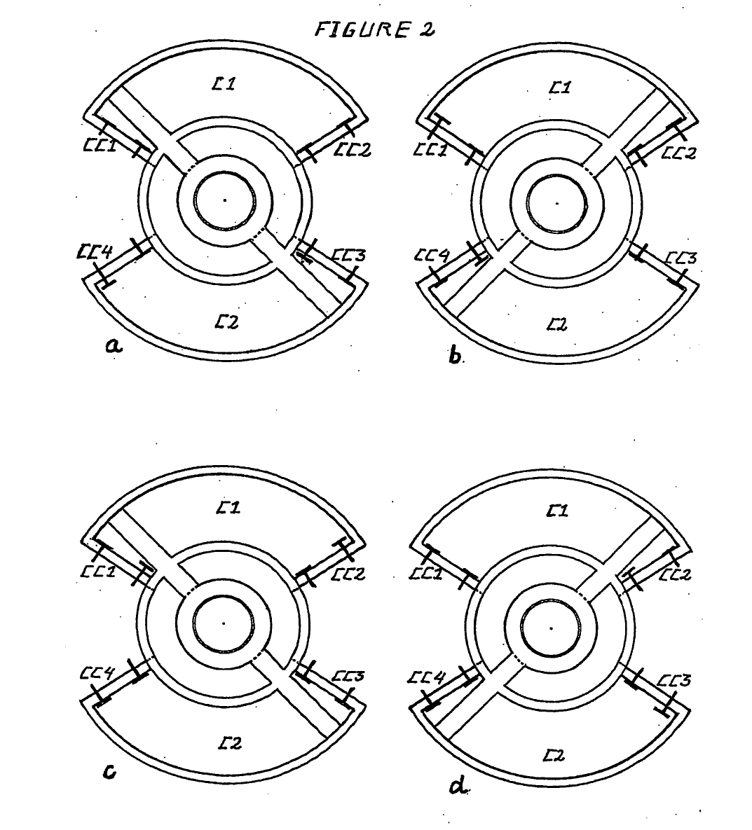

The FIG. 2 shows the four strokes of the OTTO cycle in each of the four combustion chambers (CC1, CC2, CC3, CC4) of the engine. Thus, to each stroke, the four combustion chambers are on following thermodynamic situation. 1° STROKE—FIG. 2a—CC1 is at explosion beginning; CC2 at compression beginning; CC3 at admission beginning; CC4 at escape beginning. 2° STROKE—FIG. 2b—CC1 is at escape beginning; CC2 at explosion beginning; CC3 at compression beginning; CC4 at admission beginning. 3° STROKE—FIG. 2b—CC1 is at admission beginning; CC2 at escape beginning; CC3 at explosion beginning; CC4 at compression beginning. 4° STROKE—FIG. 2d—CC1 is at compression beginning; CC2 at admission beginning; CC3 at escape beginning; CC4 at explosion beginning.

According that sequence of explosions, the pistons are activated for a to-and-fro/angular movement, because they receive the explosions impact in one and other face of the piston surface.

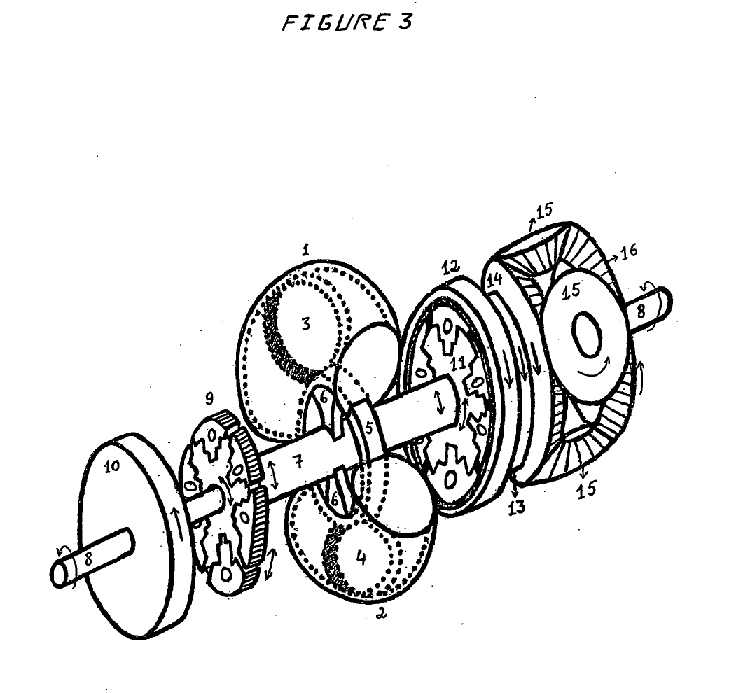

Finally the FIG. 3 shows a perspective sight of the presented engine. There, we can see the components since (1) till (16) already mentioned at FIGS. 1a and 1b. Besides that, we can see one of the ASES with its entry element (9) and outlet element (10) disjointed. Thus, we can observe that the entry element is settled by one disk with movable and indented circular sectors with special shape. These indented circular sectors can slide within adjusted cavities and so, they can connect and disconnect their special inclined cogs with the fixed adjusted cogs of the outlet element. The sliding of the circular sectors to the cogs connection is impelled by the centrifugal force of the rotative movement. The disconnection between cogs happens when the rotative movements of the entry element and outlet element are in contrary sense, because the sliding of the cogs. It is possible to avoid the contact between cogs, during this contrary movement of the cogs, using a blockade system, which stops the indented circular sectors, profiting the acceleration inertial force of the entry element The same thing can happen on the other ASES.

Then, we can, right now, describe easily the general operation of the engine. Thus, the pistons (3) and (4) activated by the consecutive explosions, which occur opportunely at four CC of both toric cylinders (1) and (2), will acquire a to-and-fro/angular movement. This movement will be transmitted to the slider, which follows the angular movement of the pistons but blocking the leak of the combustion fumes, because the permanent adjusting between the slider and the cylindrical aperture. The slider transmits its angular movement to the cranks (6), (6) and these, by its turn, make the transmission of their angular movements to the crank axle. So, the crank axle acquires a to-and-fro/angular movement. But the motor shaft must be activated always in same rotation sense. Then, the piston movement on motor sense can be transmitted directly to motor shaft by one of the ASES, but the contrary movement of the piston only can be transmitted to the motor shaft by the other ASES, if it will be inverted before that. Then, to achieve this, the 1° ASES makes the direct activation of the motor shaft when the piston movement is in motor sense, being the 2° ASES disconnected. When the piston movement is in contrary of the motor sense, then the 1° ASES is disconnected and the 2° ASES activates the motor shaft through the special gear system, which makes the inversion of the angular movement, and thus the motor shaft is activated always in same rotation direction.

Now, to finish this description is convenient to say that the presented engine, being settled by only two toric cylinders with the respective pistons, slider and cranks, assembling just one bi-cylindrical corps, can have, however, two or more bi-cylindrical corps, in parallel, actuating simultaneously over a unique crank axle and possessing only two ASES.

1a- Four-stroke internal combustion engine, with angular and alternate movement of the pistons, operating according with OTTO thermodynamic cycle, characterized by to be settled by one or more corps with 2 cylinders, which are independents between themselves and diametrically opposed, with toric format and two combustion chambers by cylinder, totalising two cylinders and four combustion chambers by bi- cylindrical corps and having, in interior of each toric cylinder, one adjusted and sliding piston with double face, totalising two pistons diametrically opposed and four piston faces by bi/cylindrical corps, being the angular and alternate movement of the pistons obtained since the gas pressure resulting of the successive explosions of a gas mixture opportunely introduced, in a certain sequence, in the 4 combustion chambers of the two toric cylinders, alternately, over one and other face of the two pistons.

2a- Four-stroke internal combustion engine, according the reivindication 1, characterized by to have their pistons laterally and rigidly fixed to one sliding and annular slider by bi-cylindrical corps, inserted in a longitudinal apertures adjusted to the slider, along of the lesser diameter surface of the toric cylinders in such a way that the angular and alternate movement of the pistons can be transmitted successively to the slider, from that to cranks and finally to one hollow axle, called crank axle, that encircle, without touching, another axle called motor shaft and thus, the slider has the purpose to transmit the angular and alternate movement of the pistons to cylinders exterior and also blocking the leaking of the combustion fumes to cylinders exterior, during the activation of the pistons, because the permanent adjusting between the slider and the cylindrical apertures.

3a- Four-stroke internal combustion engine, according the reivindications 1 and 2, characterized by the angular and alternate movement of the crank axle can be transmitted to the motor shaft, always in same rotation sense, throughout the utilization of two activation systems for the engine shaft, independents between themselves, fixed, each one, to one crank axle extremity and who activate alternately and successively the motor shaft, in such a way that when one piston, activated by the explosion fumes, slide on motor sense, it will be the first activation systems for the engine shaft, which activates directly the motor shaft, while the second will stay disconnected and when the piston slide on contrary of motor sense, it will be the second activation system for engine shaft that activates indirectly the motor shaft, in motor sense, while the first one will stay disconnected, because the interposition of an angular movement invertor system between the second activation system for the engine shaft and the motor shaft and thus the motor shaft will be impelled to rotate always in same rotation sense.
